(19) United States
(12) Patent Application Publication
(10) Pub. No.: US 2017/0358951 A1
(43) Pub. Date: Dec. 14, 2017

(54) SYSTEM AND METHOD FOR ADJUSTING A RESPONSE IN A WIRELESS POWER RECEIVER

(71) Applicant: QUALCOMM INCORPORATED, San Diego, CA (US)

(72) Inventor: Cody Burton Wheeland, San Diego, CA (US)

(21) Appl. No.: 15/178,580

(22) Filed: Jun. 10, 2016

(51) Int. Cl. H02J 50/12; H02J 7/02

(52) U.S. Cl. CPC H02J 50/12; H02J 7/025

(57) ABSTRACT

A wireless power receiver includes a receive antenna configured to generate charging current in response to a primary magnetic field, and a field adjustment element located between the receive antenna and a metal structure of the wireless power receiver, the field adjustment element configured to adjust an amount of a secondary magnetic field that may reach the receive antenna.

### FIELD

The present disclosure relates generally to wireless power. More specifically, the disclosure is directed to adjusting a response in a wireless power receiver.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless power charging systems, for example, may allow users to charge and/or power electronic devices without physical, electrical connections, thus reducing the number of components required for operation of the electronic devices and simplifying the use of the electronic device. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power receiver including a receive antenna configured to generate charging current in response to a primary magnetic field, and a field adjustment element located between the receive antenna and a metal structure of the wireless power receiver, the field adjustment element configured to adjust an amount of a secondary magnetic field that may reach the receive antenna.

Another aspect of the disclosure provides a method for adjusting a response of a receive antenna in a wireless power receiver including generating a charging current in response to a primary magnetic field, and limiting an amount of a secondary magnetic field that reaches the receive antenna in the wireless power receiver.

Another aspect of the disclosure provides a wireless power receiver including a receive antenna configured to generate charging current in response to a primary magnetic field, wherein a secondary magnetic field is generated by an eddy current in the wireless power receiver. The wireless power receiver further includes a field adjustment element located between the receive antenna and a metal structure of the wireless power receiver, the field adjustment element configured to adjust an amount of the secondary magnetic field, wherein the field adjustment element is chosen from the group consisting of a field blocking element configured to reduce a strength of the secondary magnetic field in a direction toward the receive antenna, a field blocking element configured to reduce a strength of the primary magnetic field in a direction toward a metal structure of the wireless power receiver such that the secondary magnetic field is substantially reduced, and a field altering element configured to generate a third magnetic field, the third magnetic field configured to reduce a strength of the secondary magnetic field in a direction toward the receive antenna.

Another aspect of the disclosure provides a device for wireless power transfer including means for generating a charging current in response to a primary magnetic field, and means for limiting an amount of a secondary magnetic field that reaches the means for generating the charging current.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of an exemplary wireless power transfer system, in accordance with exemplary embodiments.

FIG. 2 is a functional block diagram of an example of a wireless power transfer system, in accordance with various exemplary embodiments.

FIG. 3 is a schematic diagram of a portion of transmit circuitry or receive circuitry of FIG. 2 including a transmit or receive antenna, in accordance with exemplary embodiments.

FIG. 4 is a functional block diagram of a transmitter that may be used in the wireless power transfer system of FIG. 1, in accordance with exemplary embodiments.

FIG. 5 is a functional block diagram of a receiver that may be used in the wireless power transfer system of FIG. 1, in accordance with exemplary embodiments.

FIG. 6 is a schematic diagram of a portion of transmit circuitry that may be used in the transmit circuitry of FIG. 4.

FIG. 7 is a schematic diagram showing an exemplary receiver located on a wireless charging surface.

FIG. 8 is a schematic diagram showing an exemplary receiver located on a wireless charging surface.

FIG. 9 is a schematic diagram showing an exemplary embodiment of a wireless power transfer system having a receiver with an adjustable response.

FIG. 10 is a schematic diagram showing an exemplary embodiment of a wireless power transfer system having a receiver with an adjustable response.

FIG. 11 is a schematic diagram showing an exemplary embodiment of a wireless power transfer system having a receiver with an adjustable response.

FIG. 12 is a plan view of an exemplary embodiment of a wireless power transfer system having a receiver with an adjustable response.

FIG. 13 is a plan view of an exemplary embodiment of a wireless power transfer system having a receiver with an adjustable response

FIG. 14 is a plan view of an exemplary embodiment of a wireless power transfer system having a receiver with an adjustable response.

FIG. 15 is a schematic diagram showing an exemplary embodiment of a wireless power transfer system having a receiver with an adjustable response.

FIG. 16 is a plan view of the exemplary embodiment of the wireless power transfer system of FIG. 15.

FIG. 17 is a flowchart illustrating an exemplary embodiment of a method for adjusting a response in a wireless power receiver.

FIG. 18 is a functional block diagram of an apparatus for adjusting a response in a wireless power receiver.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Drawing elements that are common among the following figures may be identified using the same reference numerals.

Wireless power transfer may refer to transferring any form of energy associated with electric fields, magnetic fields, electromagnetic fields, or otherwise from a transmitter to a receiver without physical electrical conductors connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer.

It is desirable to have the ability to efficiently and safely transfer power for wirelessly charging rechargeable electronic devices of various sizes, shapes, and form factors. Some wireless receiver devices have attributes that may make wireless charging difficult. For example, a large receiver containing metal plate, or a receiver having a small receive resonator located near the center of a metal plate in the receiver may give rise to inconsistencies in the wireless charging field that is used to transfer power. Such an inconsistency may sometimes be referred to as a “hole” or a “peak” in the wireless charging field, and the resultant magnetic coupling will be either higher or lower than expected due to eddy current effects from the metal plate in the receiver. This leads to a wide variation in magnetic coupling and power transfer, which complicates receiver antenna design.

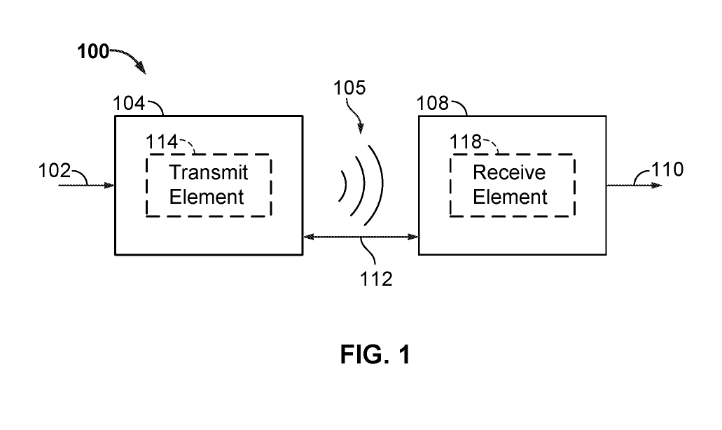

FIG. 1 is a functional block diagram of an example of a wireless power transfer system 100. Input power 102 is provided to a transmitter 104 from a power source (not shown) to generate a wireless field 105 (e.g., magnetic or electromagnetic) for performing energy transfer. A receiver 108 couples to the wireless field 105 and generates output power 110 for storing or consumption by a device (not shown in this figure) that is coupled to receive the output power 110. The transmitter 104 and the receiver 108 are separated by a distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that is within about three wavelengths, or even within about one wavelength (or a fraction thereof), of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit configured to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

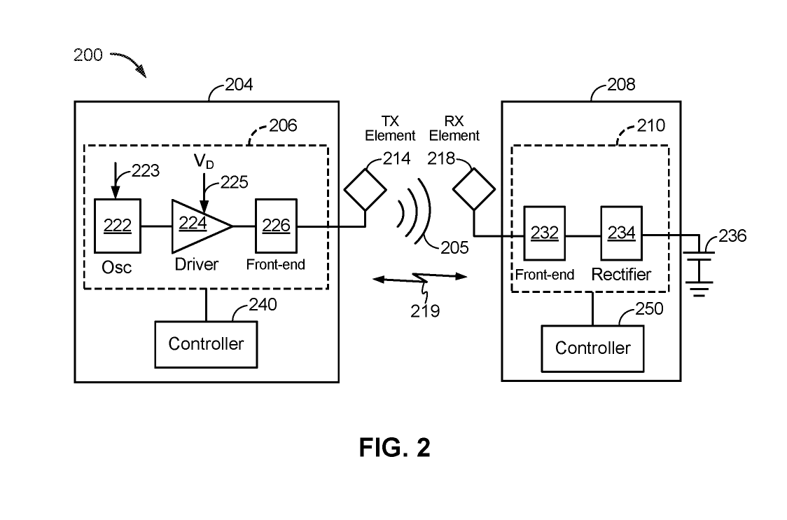

FIG. 2 is a functional block diagram of an example of a wireless power transfer system 200. The system 200 includes a transmitter 204 and a receiver 208. The transmitter 204 is configured to provide power to a power transmitting element 214 that is configured to transmit power wirelessly to a power receiving element 218 that is configured to receive power from the power transmitting element 214 and to provide power to the receiver 208.

The transmitter 204 includes transmit circuitry 206 that includes an oscillator 222, a driver circuit 224, and a front-end circuit 226. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal 225 (V_{D}). The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 generates a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

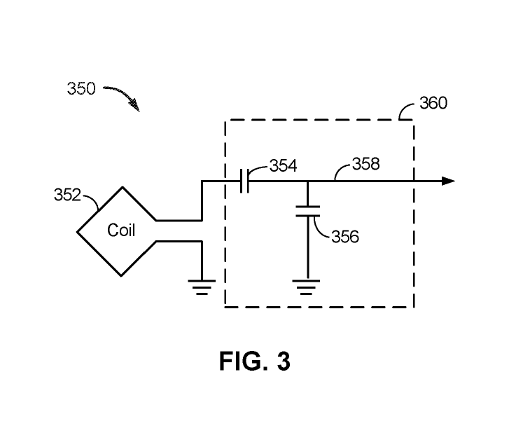

The receiver 208 (also referred to herein as power receiving unit, PRU) includes receive circuitry 210 that includes a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., Bluetooth®, Zigbee®, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery 236 (or load) coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to reduce transmission losses between the transmitter 204 and the receiver 208.

FIG. 3 is a schematic diagram of an example of a portion of the transmit circuitry 206 or the receive circuitry 210 of FIG. 2. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

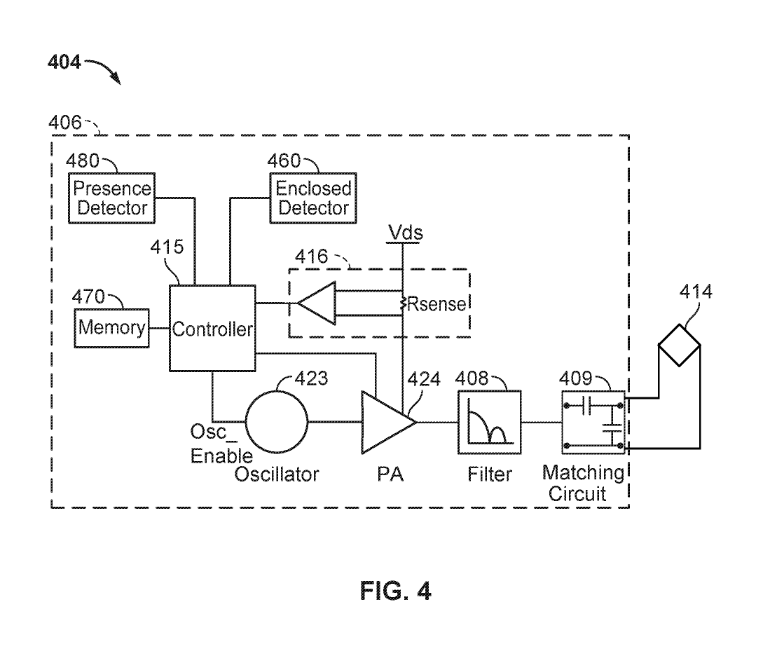

FIG. 4 is a functional block diagram of a transmitter 404 that may be used in the wireless power transfer system of FIG. 1, in accordance with exemplary embodiments. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent interference with devices and self jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the transmit antenna 414 or DC current drawn by the transmitter driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the transmitter driver circuit 424, that may be affected by the presence or absence of active receivers in the vicinity of the field generated by transmit antenna 414 as will be further described below. Detection of changes to the loading on the transmitter driver circuit 424 are monitored by controller 415 for use in determining whether to enable the oscillator 423 for transmitting energy and to communicate with an active receiver.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the transmitter driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the transmitter driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

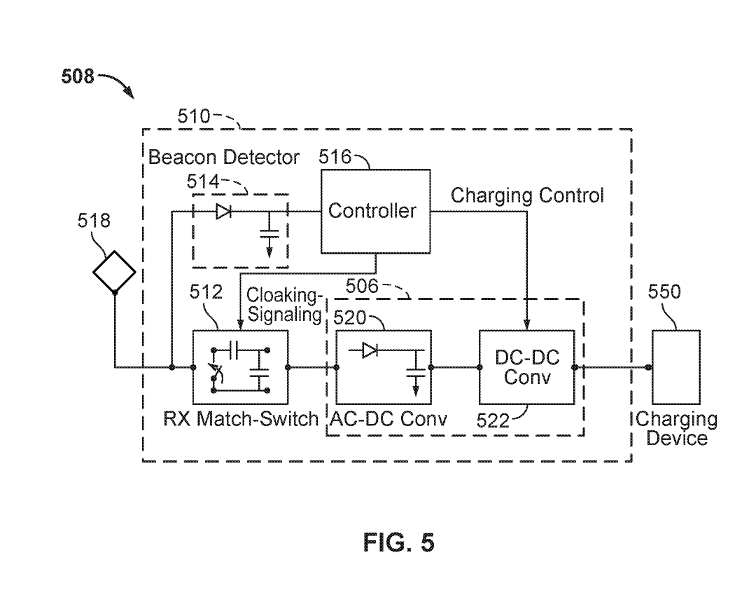

FIG. 5 is a functional block diagram of a receiver 508 that may be used in the wireless power transfer system of FIG. 1, in accordance with exemplary embodiments. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the RF energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

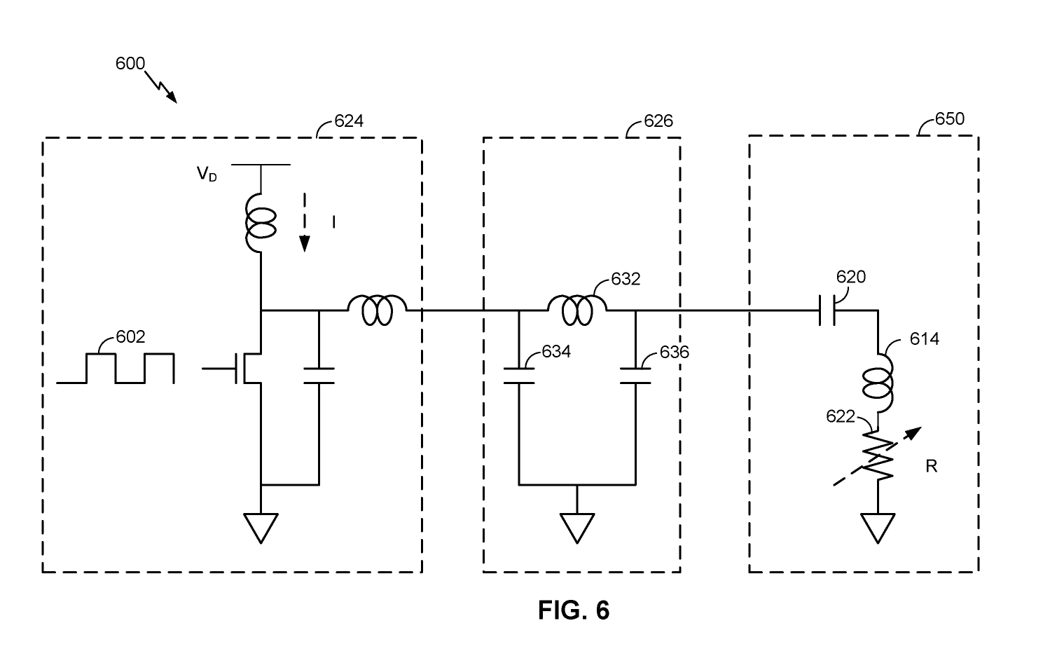

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with the embodiments described herein. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

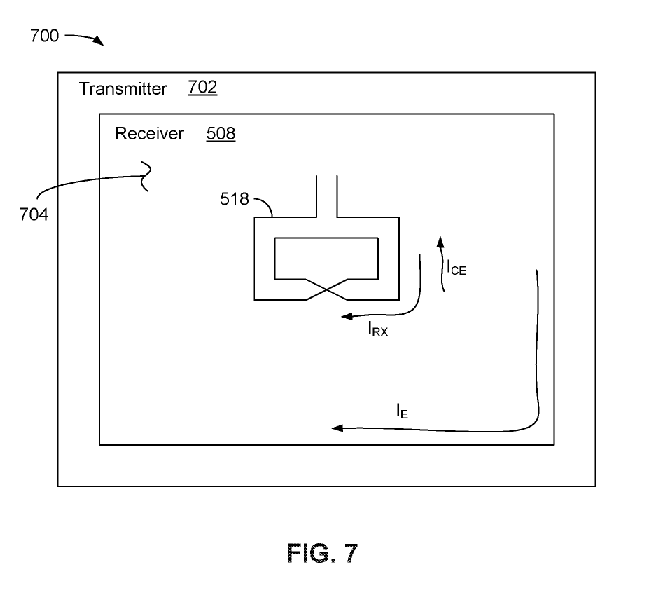

FIG. 7 is a schematic diagram 700 showing an exemplary receiver 508 located on a wireless charging surface 702 associated with a transmitter. The wireless charging surface 702 may comprise a pad, a table, a mat, a lamp, or other structure, and may comprise some or all of the elements described in the transmitter 404 of FIG. 4. In the embodiment shown in FIG. 7, the receiver 508 is smaller in area than the wireless charging surface 702. In the embodiment shown in FIG. 7, the receiver 508 comprises a primary receive antenna 518, and is relatively large compared to the size of the primary receive antenna 518. As used herein, the term “antenna” is used interchangeably with the term “coil,” and, when implemented with a capacitor, may comprise a resonant structure and be referred to as a “resonator.” As shown in FIG. 7, the receiver 508 comprises an enclosure or other metal structure 704 that may be large relative to the size of the primary receive antenna 518. In such an instance, the large metal plate causes a large reactance shift, and also causes a reduction in coupling whereby the field generated by the transmitter causes an eddy current, I_{E}, to be induced in the metal structure 704. The eddy current, I_{E}, generates a secondary magnetic field which in turn generates a current, I_{CE}, in the primary receive antenna 518 that opposes the charging current, I_{RX}, in the primary receive antenna 518. The current, I_{CE}, refers to a counter eddy current that is induced in the primary receive antenna 518 by the eddy current, I_{E}. This can cause the magnetic coupling from the transmitter 404 to the receiver 508 to be reduced when the receiver 508 is centered on the wireless charging surface 702, since the metal structure 704 covers the maximum area of transmit antenna (not shown in FIG. 7) and thus generates the maximum eddy current, I_{E}, in the metal structure 704 and hence the maximum current, I_{CE}, opposing the charging current, I_{RX}, generated in the primary receive antenna 518.

A transmit antenna (not shown) having a uniform field will exhibit a wider-than-expected range of magnetic coupling when a large metallic receiver having a relatively small primary receive antenna is used. This makes receiver and receive antenna design difficult due to a wide voltage range, and/or a receiver that cannot accept charge, or that can accept a reduced charge, at many locations on a wireless charging surface 702. As a result, the overall magnetic coupling between the transmit antenna (not shown) and the primary receive antenna 518 is reduced, resulting in a reduction in the voltage available at the receiver 508 (which may result in a voltage too low to be usable) and in an increase in the effective source impedance to a load after the rectifier in the receiver 508, thus possibly reducing available power.

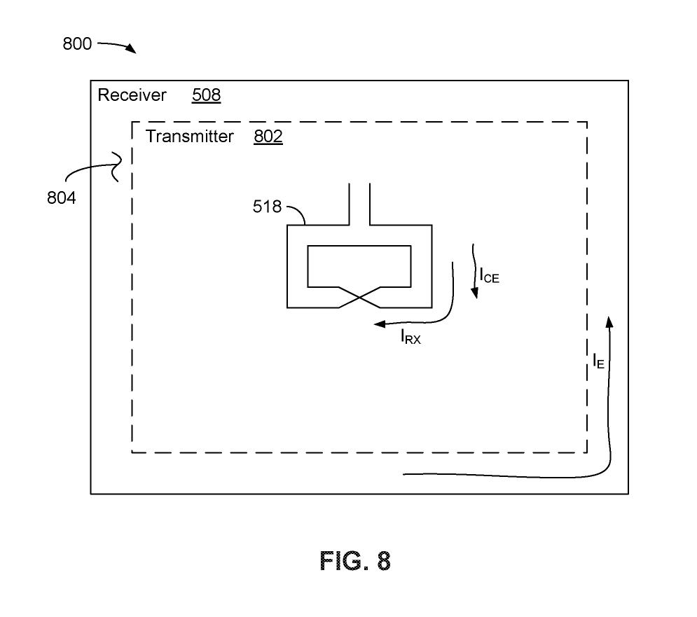

FIG. 8 is a schematic diagram 800 showing an exemplary receiver 508 located on a wireless charging surface 802 associated with a transmitter. The wireless charging surface 802 may comprise a pad, a table, a mat, a lamp, or other structure, and may comprise some or all of the elements described in the transmitter 404 of FIG. 4. In the embodiment shown in FIG. 8, the receiver 508 is larger in area than the wireless charging surface 802 and overhangs the wireless charging surface 802. In the embodiment shown in FIG. 8, the receiver 508 comprises a primary receive antenna 518, and is relatively large compared to the size of the primary receive antenna 518. As used herein, the term “antenna” is used interchangeably with the term “coil,” and, when implemented with a capacitor, may comprise a resonant structure and be referred to as a “resonator.” As shown in FIG. 8, the receiver 508 comprises an enclosure or other metal structure 804 that may be large relative to the size of the primary receive antenna 518.

In such an instance, the large metal plate causes a large reactance shift, and also causes an increase in coupling whereby the flux, referred to as eddy current, I_{E}, induced in the metal structure 804, generates a current, I_{CE}, in the receive antenna 518 that reinforces the charging current, I_{RX}, in the receive antenna. This means that magnetic coupling from the transmitter 404 to the receiver 508 is increased when the receiver 508 is centered on the wireless charging surface 802.

Stated in terms of phase, the transmit antenna (not shown) transmits a signal at 0° phase, and outside of the transmit antenna (not shown) the phase inverts to 180°. When the receiver 508 does not overhang the transmit antenna 518 (such as in the embodiment shown in FIG. 7) the eddy current, I_{E}, generated within the receiver's conductive plane (not shown) is at a phase of 180°, so it generates a field at a phase of 180° that effectively reduces the coupling between the transmit antenna (not shown) and the receive antenna 518. When the receiver 508 overhangs the transmitter (such as in the embodiment shown in FIG. 8) the eddy current, I_{E} induced by the field outside of the receive antenna 518 is at 0° phase, so the induced field reinforces the charge coupling.

When this happens, the eddy current, I_{E}, generated in the metal structure 804 is in the opposite direction from that described in FIG. 7, since the edges of the metal structure 804 extend into a “reverse field” region. In an exemplary embodiment, the “reverse field” region may be the area outside the charge area of the wireless charging surface 802 where the magnetic field wraps around the transmit antenna (not shown) in the wireless charging surface 802 and demonstrates a reverse polarity. This induces a current, I_{CE}, at zero degrees (0°) phase, in the receive antenna 518 that reinforces the current, I_{RX}, generated by the received field. As a result, the overall magnetic coupling between the transmit antenna (not shown) and the primary receive antenna 518 is increased. In some instances, receive voltage may increase beyond the limits that the receiver 508 can handle. This can damage the receiver 508 and/or result in expensive, large and inefficient designs.

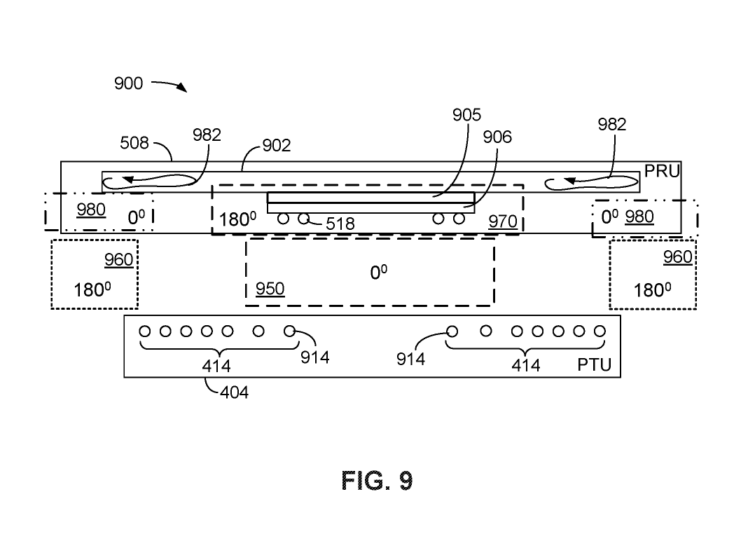

FIG. 9 is a schematic diagram showing an exemplary embodiment of a wireless power transfer system 900 having a receiver with an adjustable response. The wireless power transfer system 900 includes a transmitter (also referred to as a power transmit unit (PTU) 404 and a receiver (also referred to as a power receiving unit (PRU) 508. The transmitter 404 comprises a transmit antenna 414 having one or more coils 914. The other elements of the transmitter 404 are not shown in FIG. 9 for simplicity.

The receiver 508 comprises a receive antenna 518, a ground plane 902, a field adjustment element 905 and a ferrite element 906. In an exemplary embodiment, the field adjustment element 905 may comprise a metal or a metallic element configured to adjust, modify, contain or otherwise adjust the magnetic field experienced by the receiver 508. In an exemplary embodiment, the field adjustment element 905 may comprise one or more ferrite elements, in addition to the ferrite element 906. The ground plane 902 may be substantially formed from a metal or metallic electrically conductive material and may also be part of a printed circuit board (PCB) (not shown) that contains circuitry related to the receiver 508. The ferrite element 906 provides a magnetically conductive path for the magnetic field generated by the receive antenna, which may otherwise be blocked by the ground plane 902.

In an exemplary embodiment, in general, the field generated by the transmit antenna 414 comprises a 0° phase field generally inside of the coils 914 in the region 950 and comprises a 180° phase field generally outside of the coils 914 in the region 960. The field generally inside of the coils 914 in the region 950 may be referred to as a primary magnetic field. If the 0° phase field in the region 950 reaches the ground plane 902 the field in the region 970 that is generated by the ground plane 902 is generally generated at a 180° phase that opposes the original 0° phase field in the region 950 and decreases the coupling between the transmit antenna 414 and the receive antenna 518. The wireless power receiver 508 is typically designed to accommodate this condition. The 180° phase field generated by the transmit antenna 414 in the region 960 that is generated generally outside of the coils 914 may reach the ground plane 902 and generate an eddy current 982 in the ground plane 902. The eddy current 982 may generate a field at a phase of 0° in the region 980 that reinforces the original 0° phase field in the region 950 and which increases the coupling between the transmit antenna 414 and the receive antenna 518. The field in the region 980 may be referred to as a secondary magnetic field. This condition can be problematic, such as by causing excessive coupling that may lead to an overvoltage condition in the wireless power receiver 508, such that eliminating, reducing, blocking, or otherwise mitigating the effect of the field in the region 980 is desired. To eliminate or mitigate the effect of the field in the region 980 and its effect on the wireless power receiver 508, it is desirable to prevent the field in the region 980 from reaching the receive antenna 518. The regions 950, 960, 970 and 980 are illustrated as rectangular regions for convenience of illustration only. Those skilled in the art understand that magnetic fields are generally not rectangular in shape, but may take other shapes.

In an exemplary embodiment, the field adjustment element 905 may be configured as a center field blocking element configured to reduce the strength of, to block, or otherwise mitigate the effect of the field in the region 980 generated by the eddy current 982 on the receive antenna 518. In exemplary embodiments, the field adjustment element 905 may comprise coils, segments or blocks of metallic or other conductive material, ferrite material, or other structures configured to adjust a response of the receiver 508. For example, the field adjustment element 905 may cancel or diminish the strength of the magnetic field generated by the eddy current 982 in the region 980 that may otherwise reach the receive antenna 518, and may help to cancel or diminish the likelihood that the eddy current 982 causes the detrimental effects described herein. Preventing or limiting the strength of the magnetic field generated by the eddy current 982 that may reach the transmit antenna 518 prevents the eddy current 982 from possibly causing an overvoltage condition in the wireless power receiver 508.

It is desirable to prevent the field in the region 980 generated by the eddy current 982 from coupling to the receive antenna 518. In this exemplary embodiment, the field adjustment element 905 prevents the field in the region 980 generated by the eddy current 982 from coupling to the receive antenna 518, thus preventing excessive coupling that may lead to an overvoltage condition in the receiver 508.

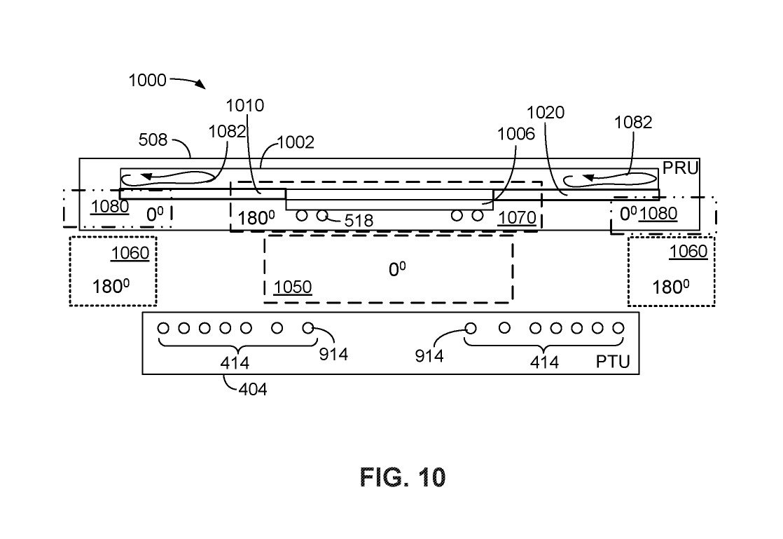

FIG. 10 is a schematic diagram showing an exemplary embodiment of a wireless power transfer system 1000 having a receiver with an adjustable response. The wireless power transfer system 1000 includes a transmitter 404 and a receiver 508. The transmitter 404 comprises a transmit antenna 414 having one or more coils 914. The other elements of the transmitter 404 are not shown in FIG. 10 for simplicity.

The receiver 508 comprises a receive antenna 518, a ground plane 1002, a field adjustment element 1010, a field adjustment element 1020, and a ferrite element 1006. In an exemplary embodiment, the field adjustment element 1010 and the field adjustment element 1020 may comprise a metal or a metallic element configured to adjust, modify, contain or otherwise adjust the magnetic field developed by the receiver 508. The ground plane 1002 may be substantially formed from a metal or metallic electrically conductive material and may also be part of a printed circuit board (PCB) (not shown) that contains circuitry related to the receiver 508. The ferrite element 1006 provides a magnetically conductive path for the magnetic field generated by the receive antenna 518, which may otherwise be blocked by the ground plane 1002.

In an exemplary embodiment, in general, the field generated by the transmit antenna 414 comprises a 0° phase field generally inside of the coils 914 in the region 1050 and comprises a 180° phase field generally outside of the coils 914 in the region 1060. The field generally inside of the coils 914 in the region 1050 may be referred to as a primary magnetic field. If the 0° phase field in the region 1050 reaches the ground plane 1002 the field in the region 1070 that is generated by the ground plane 1002 is generally generated at a 180° phase that opposes the original 0° phase field in the region 1050 and decreases the coupling between the transmit antenna 414 and the receive antenna 518. The wireless power receiver 508 is typically designed to accommodate this condition. The 180° phase field generated by the transmit antenna 414 in the region 1060 that is generated generally outside of the coils 914 may reach the ground plane 1002 and generate an eddy current 1082 in the ground plane 1002. The eddy current 1082 may generate a field at a phase of 0° in the region 1080 that reinforces the original 0° phase field in the region 1050 and which increases the coupling between the transmit antenna 414 and the receive antenna 518. The field in the region 1080 may be referred to as a secondary magnetic field. This condition can be problematic, such as by causing excessive coupling that may lead to an overvoltage condition in the wireless power receiver 508, such that eliminating the field in the region 1080 is desired. To eliminate the field in the region 1080, it is desirable to prevent the field in the region 1060 from reaching the ground plane 1002 and generating an eddy current 1082. The regions 1050, 1060, 1070 and 1080 are illustrated as rectangular regions for convenience of illustration only. Those skilled in the art understand that magnetic fields are generally not rectangular in shape, but may take other shapes.

In an exemplary embodiment, the field adjustment element 1010 and the field adjustment element 1020 may be configured as edge field blocking elements configured to cancel or diminish the magnetic field generated by the transmit antenna 414 toward the periphery or edges of the receiver 508, generally in the region 1060 and to prevent the field in the region 1060 from reaching the ground plane 1002 and generating the eddy current 1082. In exemplary embodiments, the field adjustment elements 1010 and 1020 may comprise coils, segments of metallic material, ferrite material, or other structures configured to adjust a response of the receiver 508. For example, the field adjustment element 1010 and the field adjustment element 1020 may prevent, cancel or diminish the strength of the magnetic field generated by the transmit antenna 414 outside of periphery of the transmit antenna 414 in the region 1060, and prevent it from reaching the ground plane 1002. Preventing or limiting the strength of the field in the region 1060 that may reach the ground plane 1002 prevents, or at least minimizes any eddy current 1082 from being developed in the ground plane 1002, and thereby prevents the generation of a 0° phase field in the region 1080 which may couple with the field in the region 1050 and thus create an overvoltage condition in the wireless power receiver 508. In an exemplary embodiment, the field adjustment elements 1010 and 1020 cancel or diminish the strength of the magnetic field generated by the transmit antenna 414 in the region 1060 so that the magnetic field in the region 1060 does not reach the ground plane 1002, particularly above the field adjustment elements 1010 and 1020.

In an exemplary embodiment, when the magnetic field generated by the transmit antenna 414 reaches the ground plane 1002, an eddy current 1082 may be generated in the ground plane 1002, possibly giving rise to a 0° phase field in the region 1080, which may couple with the 0° phase field in the region 1050, and result in excessive coupling that may lead to an overvoltage condition in the wireless power receiver 508. The eddy current 1082 could exist anywhere that the current could flow in the ground plane 1002, and in this exemplary embodiment, is shown toward the edges of the ground plane 1002 generated as a result of the field in the region 1060 reaching the ground plane 1002. Therefore, it is desirable to prevent such an inverted field from being developed in the ground plane 1002 (or in any other metal structure associated with the wireless power receiver 508) and coupling to the receive antenna 518. In the embodiment shown in FIG. 10, the field adjustment elements 1010 and 1020 prevent the eddy current 1082 from being generated in the ground plane 1002 above the field adjustment elements 1010 and 1020 and preventing the formation of a magnetic field in the region 1080, thus preventing excessive coupling that may lead to an overvoltage condition in the receiver 508.

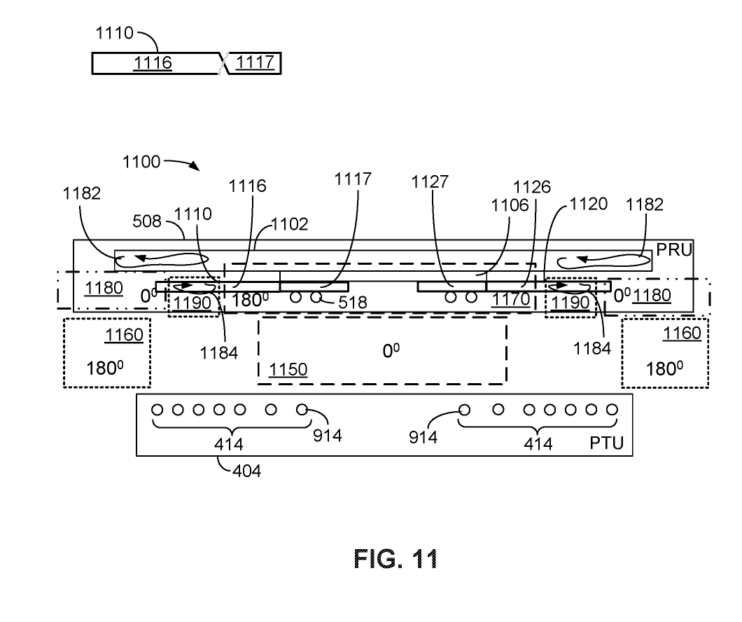

FIG. 11 is a schematic diagram showing an exemplary embodiment of a wireless power transfer system 1100 having a receiver with an adjustable response. The wireless charging system 1100 includes a transmitter 404 and a receiver 508. The transmitter 404 comprises a transmit antenna 414 having one or more coils 914. The other elements of the transmitter 404 are not shown in FIG. 11 for simplicity.

The receiver 508 comprises a receive antenna 518, a ground plane 1102, a field adjustment element 1110, a field adjustment element 1120, and a ferrite element 1106. In an exemplary embodiment, the field adjustment element 1110 and the field adjustment element 1120 may comprise a metal or metallic elements configured to adjust, modify, contain or otherwise adjust the magnetic field developed by the receiver 508. In an exemplary embodiment, the field adjustment element 1110 includes a portion 1116 and a portion 1117. In an exemplary embodiment, the portion 1116 can be formed in such a way as to be inverted with respect to the portion 1117. As used herein, the term “inverted” refers to the portion 1116 being wound or coiled in a direction opposite of the winding or coiling of the portion 1117. Similarly, the field adjustment element 1120 includes a portion 1126 and a portion 1127. In an exemplary embodiment, the portion 1126 can be formed in such a way as to be inverted with respect to the portion 1127, similar to the portions 1116 and 1117 of the field adjustment element 1110. The ground plane 1102 may be substantially formed from a metal or metallic electrically conductive material and may also be part of a printed circuit board (PCB) (not shown) that contains circuitry related to the receiver 508. The ferrite element 1106 provides a magnetically conductive path for the magnetic field generated by the receive antenna 518, which may otherwise be blocked by the ground plane 1102.

In an exemplary embodiment, in general, the field generated by the transmit antenna 414 comprises a 0° phase field generally inside of the coils 914 in the region 1150 and comprises a 180° phase field generally outside of the coils 914 in the region 1160. The field generally inside of the coils 914 in the region 1150 may be referred to as a primary magnetic field. If the 0° phase field in the region 1150 reaches the ground plane 1102 the field in the region 1170 that is generated by the ground plane 1102 is generally generated at a 180° phase that opposes the original 0° phase field in the region 1150 and decreases the coupling between the transmit antenna 414 and the receive antenna 518. The wireless power receiver 508 is typically designed to accommodate this condition. The 180° phase field generated by the transmit antenna 414 in the region 1160 that is generated generally outside of the coils 914 may reach the ground plane 1102 and generate an eddy current 1182 in the ground plane 1102. The eddy current 1182 may generate a field at a phase of 0° in the region 1180 that reinforces the original 0° phase field in the region 1150 and which increases the coupling between the transmit antenna 414 and the receive antenna 518. The field in the region 1180 may be referred to as a secondary magnetic field. This condition can be problematic, such as by causing excessive coupling that can lead to an overvoltage condition in the wireless power receiver 508, such that eliminating, reducing, blocking, or otherwise mitigating the effect of the field in the region 1180 is desired. To eliminate or mitigate the effect of the field in the region 1180 and its effect on the wireless power receiver 508, it is desirable to prevent the field in the region 1180 from reaching the receive antenna 518. The regions 1150, 1160, 1170 and 1180 are illustrated as rectangular regions for convenience of illustration only. Those skilled in the art understand that magnetic fields are generally not rectangular in shape, but may take other shapes.

In an exemplary embodiment, the field adjustment element 1110 and the field adjustment element 1120 may be referred to as field altering elements that may be configured as field inverting elements configured to reduce, block, or otherwise mitigate the effect of the magnetic field in the region 1180 generated by the eddy current 1182 on the receive antenna 518. Preventing or limiting the strength of a magnetic field in the region 1180 that may reach the receive antenna 518 prevents excessive coupling and may prevent an overvoltage condition from developing in the wireless power receiver 508.

In an exemplary embodiment, when the magnetic field generated by the transmit antenna 414 reaches the ground plane 1102, an eddy current 1182 may be generated in the ground plane 1102 possibly giving rise to a 0° phase field in the region 1180, which may couple with the 0° phase field in the region 1150, and result in excessive coupling that may lead to an overvoltage condition in the receiver 508. The eddy current 1182 could exist anywhere that the current could flow in the ground plane 1102 and in this exemplary embodiment, is shown toward the edges of the ground plane 1102. Therefore, it is desirable to prevent the field in the region 1180 from reaching the receive antenna 518.

In an exemplary embodiment, in response to the magnetic field in the region 1180 generated by the eddy current 1182, the field adjustment element 1110 and the field adjustment element 1120 may generate a second eddy current 1184 at a phase opposite the phase of the eddy current 1182. The second eddy current 1184 may generate a magnetic field in the region 1190 that counteracts, or reduces the strength of, the magnetic field in the region 1180, thus preventing the magnetic field in the region 1180 from excessively coupling to the receive antenna 518. The field in the region 1190 may be referred to as a third magnetic field.

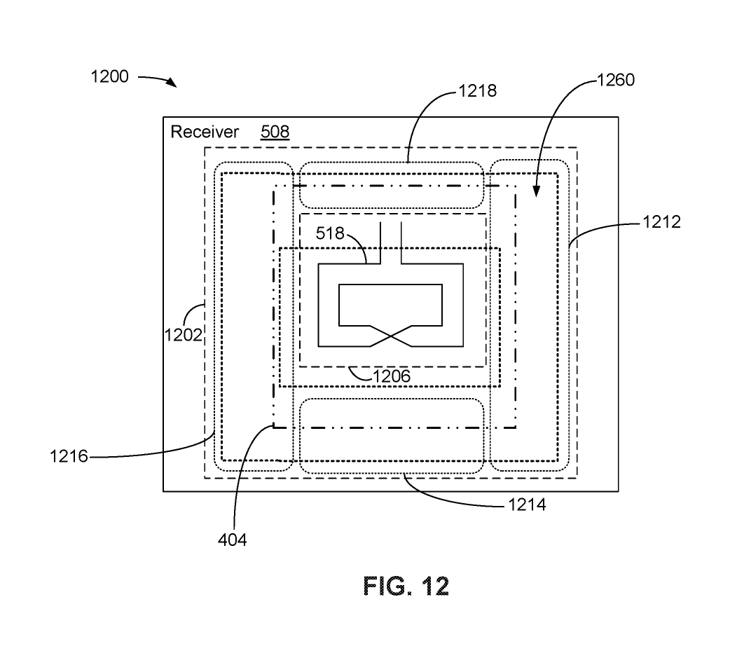

FIG. 12 is a plan view of an exemplary embodiment of a wireless power transfer system 1200 having a receiver with an adjustable response. The wireless power transfer system 1200 shows a transmitter 404 over which a receiver 508 having a receive antenna 518 may be located. The plan view also shows in phantom a ground plane 1202 and a ferrite element 1206, which may typically located between the ground plane 1202 and the receive antenna 518. The ground plane 1202 and the ferrite element 1206 are similar to the ground plane and ferrite element discussed in FIGS. 9, 10 and 11.

The wireless power transfer system 1200 also comprises field adjustment elements shown as exemplary shorted coils 1212, 1214, 1216 and 1218. In an exemplary embodiment, the shorted coils 1212, 1214, 1216 and 1218 are shown as being located around a periphery of the receive antenna 518. In an exemplary embodiment, the shorted coils 1212, 1214, 1216 and 1218 may be configured to prevent a magnetic field in the region 1260 from reaching the ground plane 1202. In an exemplary embodiment, the shorted coils 1212, 1214, 1216 and 1218 are relatively large relative to the receive antenna 518 and are arranged as edge-blocking elements configured to prevent a magnetic field in the region 1260 from reaching the ground plane 1202 and to prevent the subsequent development of an eddy current in the ground plane 1202, as described herein. In an exemplary embodiment, the shorted coils 1212, 1214, 1216 and 1218 can diminish or prevent the magnetic field generated in the region 1260 by the transmit antenna (not shown) from reaching the ground plane 1202.

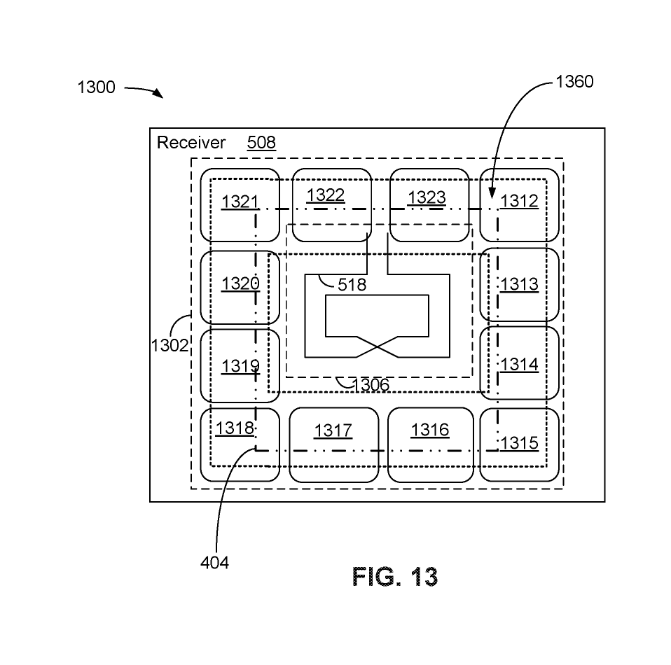

FIG. 13 is a plan view of an exemplary embodiment of a wireless power transfer system 1300 having a receiver with an adjustable response. The wireless power transfer system 1300 shows a transmitter 404 over which a receiver 508 having a receive antenna 518 may be located. The plan view also shows in phantom a ground plane 1302 and a ferrite element 1306, which may typically located between the ground plane 1302 and the receive antenna 518. The ground plane 1302 and the ferrite element 1306 are similar to the ground plane and ferrite element discussed in FIGS. 9, 10, 11 and 12.

The wireless power transfer system 1300 also comprises field adjustment elements shown as exemplary shorted coils 1312, 1313, 1314, 1315, 1316, 1317, 1318, 1319, 1320, 1321, 1322 and 1323. In an exemplary embodiment, the shorted coils 1312 through 1323 are shown as being located around a periphery of the receive antenna 518. In an exemplary embodiment, the shorted coils 1312 through 1323 may be configured to prevent a magnetic field in the region 1360 from reaching the ground plane 1302. In an exemplary embodiment, the shorted coils 1312 through 1323 are somewhat smaller than the shorted coils described in FIG. 12 and are arranged as edge-blocking elements configured to prevent a magnetic field in the region 1360 from reaching the ground plane 1302 and to prevent the subsequent development of an eddy current in the ground plane 1302, as described herein. In an exemplary embodiment, the shorted coils 1312 through 1323 can diminish or prevent the magnetic field generated in the region 1360 by the transmit antenna (not shown) from reaching the ground plane 1302.

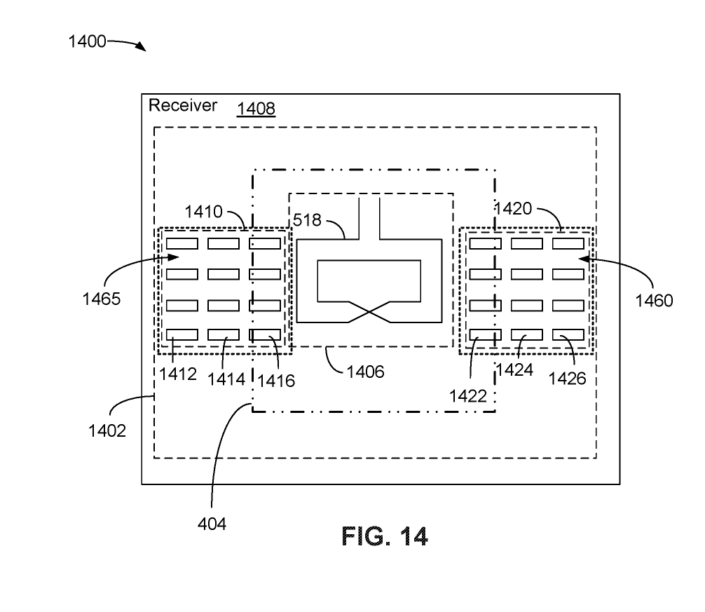

FIG. 14 is a plan view of an exemplary embodiment of a wireless power transfer system 1400 having a receiver 1408 with an adjustable response. The wireless power transfer system 1400 shows a transmitter 404 over which a receiver 508 having a receive antenna 518 may be located. The plan view also shows in phantom a ground plane 1402 and a ferrite element 1406, which may be typically located between the ground plane 1402 and the receive antenna 518. The ground plane 1402 and the ferrite element 1406 are similar to the ground plane and ferrite element discussed in FIGS. 9, 10, 11, 12 and 13.

In an exemplary embodiment, conductive plane blocks, such as, for example, the ground plane blocks 1412, 1414 and 1416, are shown as three segments in a field of twelve ground plane blocks that comprise the field adjustment element 1410, and the ground plane blocks 1422, 1424 and 1426 are shown as three segments in a field of twelve ground plane blocks that comprise the field adjustment element 1420. In an exemplary embodiment, the field adjustment elements 1410 and 1420 may be configured to prevent a magnetic field in the region 1460 and the region 1465 from reaching the ground plane 1402. In an exemplary embodiment, the field adjustment elements 1410 and 1420 comprise small individual blocks (exemplary blocks being shown using reference numerals 1412, 1414, 1416, 1422, 1424 and 1426) of metal, or metallic material, arranged in a rectangular grid to prevent a magnetic field in the region 1460 and the region 1465 from reaching the ground plane 1402 and to prevent the subsequent development of an eddy current in the ground plane 1402, as described herein. In an exemplary embodiment, the field adjustment elements 1410 and 1420 can diminish or prevent the magnetic field generated in the regions 1460 and 1465 by the transmit antenna (not shown) from reaching the ground plane 1402.

Although shown as relatively large coils in FIG. 12, as smaller coils in FIG. 13 and as discrete blocks in FIG. 14, the field adjustment elements may be implemented using other structures, other shapes, and in other configurations, depending on implementation. For example, the field adjustment elements may be made from, or may include ferrite structures covering the gaps between the different elements in a wireless power receiver. Specific sizes and numbers of field adjustment elements are dependent on the size of the wireless power receiver and on implementation.

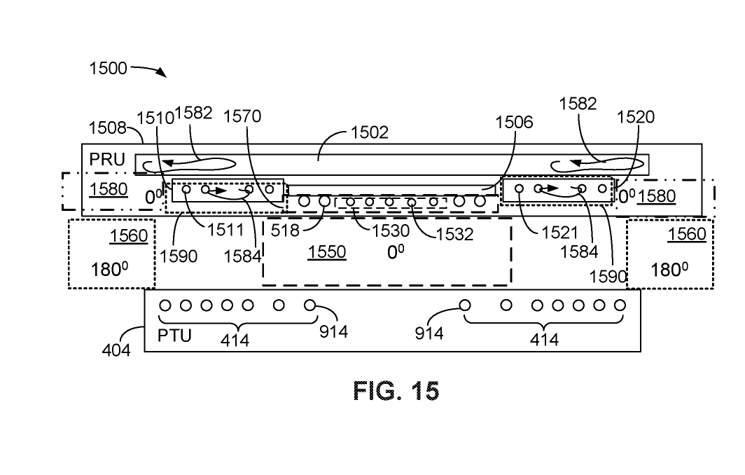

FIG. 15 is a schematic diagram showing an exemplary embodiment of a wireless power transfer system 1500 having a receiver with an adjustable response. The embodiment shown in FIG. 15 is an alternative embodiment of the wireless power transfer system 1100 shown in FIG. 11. The wireless power transfer system 1500 includes a transmitter (also referred to as a power transmit unit (PTU) 404 and a receiver 1508. The transmitter 404 comprises a transmit antenna 414 having one or more coils 914. The other elements of the transmitter 404 are not shown in FIG. 15 for simplicity.

The receiver 1508 comprises a receive antenna 518, a ground plane 1502, and a ferrite element 1506. The ground plane 1502 may be substantially formed from a metal or metallic electrically conductive material and may also be part of a printed circuit board (PCB) (not shown) that contains circuitry related to the receiver 1508. The ferrite element 1506 provides a magnetically conductive path for the magnetic field generated by the receive antenna, which may otherwise be blocked by the ground plane 1502.

The receiver 1508 also comprises exemplary field adjustment elements 1510 and 1520. In an exemplary embodiment, the effect of the field adjustment elements 1510 and 1520 may be similar to the effect provided by the field adjustment elements 1110 and 1120 described above. In an exemplary embodiment, the field adjustment element 1510 may comprise one or more coils, an exemplary one of which is shown using reference numeral 1511, wound in a first direction outside of the receive antenna 518, and the field adjustment element 1520 may comprise one or more coils, an exemplary one of which is shown using reference numeral 1521, wound in the first direction outside of the receive antenna 518. The receiver 1508 also comprises a field adjustment element 1530. In an exemplary embodiment, the field adjustment element 1530 may comprise one or more coils, an exemplary one of which is shown using reference numeral 1532 wound in a second direction inside of the receive antenna 518. In an exemplary embodiment, the first direction is opposite the second direction such that the one or more coils 1511 and 1521 are wound in a direction opposite the direction in which the coil 1532 is wound.

In an exemplary embodiment, the one or more coils 1511 and 1521 and the coil 1532 can be configured to adjust a response of the receiver 1508. For example, the one or more coils 1511 and 1521 and the coil 1532 can be configured to reduce, block, or otherwise mitigate the effect of the magnetic field in the region 1580 generated by the eddy current 1582 on the receive antenna 518. Preventing or limiting a magnetic field in the region 1580 from reaching the receive antenna 518 prevents excessive coupling and may prevent an overvoltage condition from developing in the wireless power receiver 508.

In an exemplary embodiment, when the magnetic field generated by the transmit antenna 414 reaches the ground plane 1502, an eddy current 1582 may be generated in the ground plane 1502 possibly giving rise to a 0° phase field in the region 1580, which may couple with the 0° phase field in the region 1550 (the primary magnetic field), and result in excessive coupling that may lead to an overvoltage condition in the receiver 1508. The field in the region 1580 may be referred to as a secondary magnetic field. The eddy current 1582 could exist anywhere that the current could flow in the ground plane 1502 and in this exemplary embodiment, is shown toward the edges of the ground plane 1502. Therefore, it is desirable to prevent the field in the region 1580 from reaching the receive antenna 518.

In an exemplary embodiment, in response to the magnetic field in the region 1580 generated by the eddy current 1582, the field adjustment elements 1510, 1520 and 1530 may generate a second eddy current 1584 at a phase opposite the phase of the eddy current 1582. The second eddy current 1584 may generate a magnetic field in the region 1590 that counteracts, or reduces the strength of, the magnetic field in the region 1580, thus preventing the magnetic field in the region 1580 from excessively coupling to the receive antenna 518, and thus preventing excessive coupling that may lead to an overvoltage condition in the receiver 1508. The field in the region 1590 may be referred to as a third magnetic field.

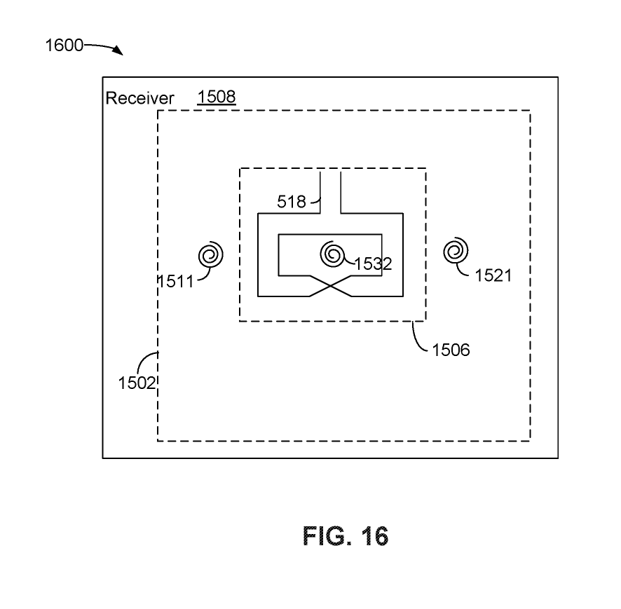

FIG. 16 is a plan view of the exemplary embodiment of the wireless power transfer system of FIG. 15. The plan view 1600 shows the receiver 1508 and shows in phantom the ground plane 1502 and the ferrite element 1506. In an exemplary embodiment, the coils 1511 and 1521 are wound in a first direction and are located outside of the receive antenna 518, and the coil 1532 is wound in a second direction and is located inside of the receive antenna 518. In an exemplary embodiment, the first direction is opposite the second direction such that the one or more coils 1511 and 1521 are wound in a direction opposite the direction in which the coil 1532 is wound. In an exemplary embodiment, the one or more coils 1511 and 1521 and the coil 1532 may be configured to develop a magnetic field responsive to the magnetic field generated by the eddy current in the receiver 1508, such that the magnetic field developed in the one or more coils 1511 and 1521 and the coil 1532 can counteract the effect of the magnetic field generated by the eddy current in the receiver 1508, as described above.

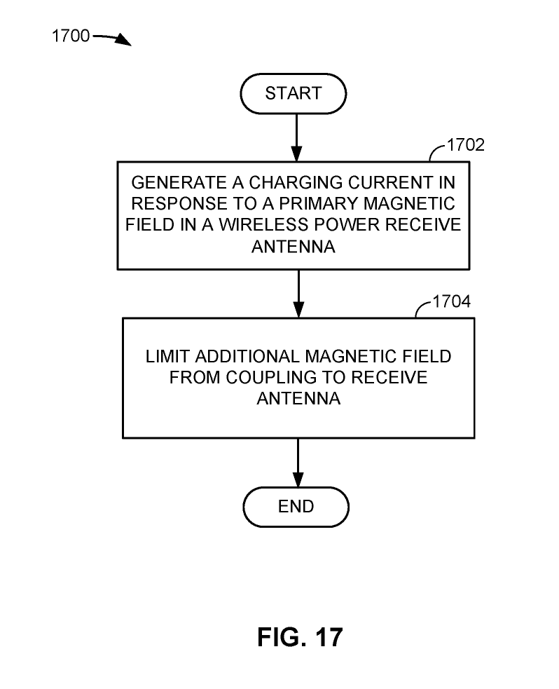

FIG. 17 is a flowchart 1700 illustrating an exemplary embodiment of a method for adjusting a response in a wireless power receiver. The blocks in the method 1700 can be performed in or out of the order shown.

In block 1702, in an exemplary embodiment, a charging current is generated in response to a primary magnetic field in a wireless power receiver antenna.

In block 1704, an additional magnetic field is prevented from coupling to the receive antenna.

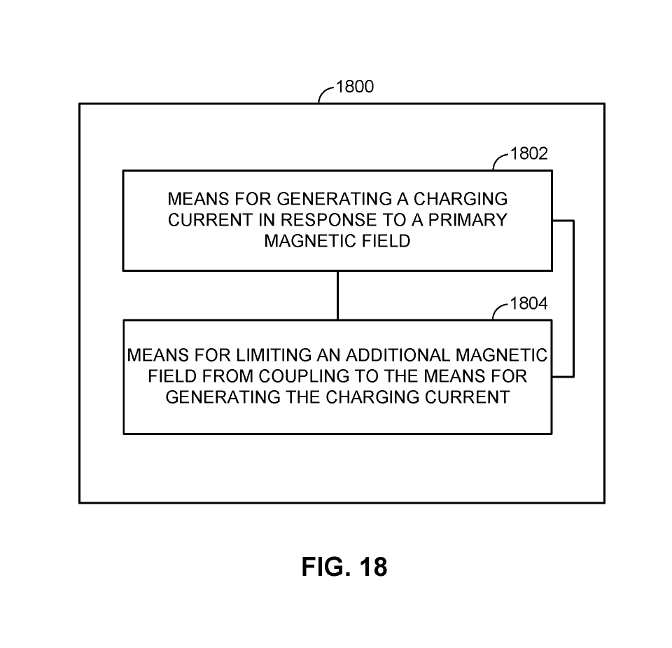

FIG. 18 is a functional block diagram of an apparatus 1800 for adjusting a response in a wireless power receiver. The apparatus 1800 comprises means 1802 for generating a charging current in response to a primary magnetic field in a wireless power receiver. In certain embodiments, the means 1802 for generating a charging current in response to a primary magnetic field in a wireless power receiver can be configured to perform one or more of the function described in operation block 1702 of method 1700 (FIG. 17). In an exemplary embodiment, the means 1802 for generating a charging current in response to a primary magnetic field in a wireless power receiver may comprise the structure shown in any of FIG. 9 through FIG. 16.

The apparatus 1800 further comprises means 1804 for limiting an additional magnetic field from coupling to the means for generating the charging current. In certain embodiments, the means 1804 for limiting an additional magnetic field from coupling to the means for generating the charging current can be configured to perform one or more of the function described in operation block 1704 of method 1700 (FIG. 17). In an exemplary embodiment, the means 1804 for limiting an additional magnetic field from coupling to the means for generating the charging current may comprise the structure shown in any of FIG. 9 through FIG. 16.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A wireless power receiver, comprising:
a receive antenna configured to generate charging current in response to a primary magnetic field; and
a field adjustment element located between the receive antenna and a metal structure of the wireless power receiver, the field adjustment element configured to adjust an amount of a secondary magnetic field that may reach the receive antenna.

2. The wireless power receiver of claim 1, wherein the secondary magnetic field is generated by an eddy current in the wireless power receiver and the field adjustment element comprises a field blocking element configured to reduce a strength of the secondary magnetic field in a direction toward the receive antenna.

3. The wireless power receiver of claim 1, wherein the field adjustment element comprises a field blocking element configured to reduce a strength of the primary magnetic field in a direction toward the metal structure of the wireless power receiver such that the secondary magnetic field is substantially reduced.

4. The wireless power receiver of claim 1, wherein the field adjustment element comprises a field altering element configured to generate a third magnetic field, the third magnetic field configured to reduce a strength of the secondary magnetic field in a direction toward the receive antenna.

5. The wireless power receiver of claim 1, wherein the field adjustment element comprises at least one shorted coil configured to reduce a strength of the secondary magnetic field in a direction toward the receive antenna.

6. The wireless power receiver of claim 1, wherein the field adjustment element comprises at least one ferrite element configured to reduce a strength of the secondary magnetic field in a direction toward receive antenna.

7. The wireless power receiver of claim 1, wherein the field adjustment element comprises at least one of a coil and a ferrite element configured to reduce a strength of the primary magnetic field in a direction toward the metal structure of the wireless power receiver.

8. The wireless power receiver of claim 1, wherein the field adjustment element comprises at least one inverted coil having a first coil portion and a second coil portion, the first coil portion being inverted with respect to the second coil portion, the at least one inverted coil configured to generate a third magnetic field configured to reduce a strength of the secondary magnetic field in a direction toward the receive antenna.

9. The wireless power receiver of claim 1, wherein the field adjustment element comprises at least one or more of a coil, a conductive plane block, a ferrite element, and an inverted coil.

10. The wireless power receiver of claim 1, wherein the field adjustment element comprises at least one ferrite element and at least one metallic element.

11. The wireless power receiver of claim 1, wherein the field adjustment element comprises:
at least one first coil wound in a first direction and located outside a periphery of the receive antenna; and
at least one second coil wound in a second direction and located inside a periphery of the receive antenna, the first coil and the second coil configured to generate a third magnetic field configured to reduce a strength of the secondary magnetic field in a direction toward the receive antenna.

12. The wireless power receiver of claim 1, wherein the field adjustment element at least partially prevents an eddy current from forming in a periphery of the metal structure of the wireless power receiver.

13. A method for adjusting a response of a receive antenna in a wireless power receiver, comprising:
generating a charging current in response to a primary magnetic field; and
limiting an amount of a secondary magnetic field that reaches the receive antenna in the wireless power receiver.

14. The method of claim 13, wherein the secondary magnetic field is generated by an eddy current in the wireless power receiver and limiting an amount of the secondary magnetic field comprises reducing a strength of the secondary magnetic field in a direction toward the receive antenna.

15. The method of claim 13, wherein limiting an amount of the secondary magnetic field comprises reducing a strength of the primary magnetic field in a direction toward a metal structure of the wireless power receiver.

16. The method of claim 15, wherein reducing a strength of the primary magnetic field in a direction toward a metal structure of the wireless power receiver reduces an amount of an eddy current forming in a periphery of the metal structure of the wireless power receiver.

17. The method of claim 13, wherein limiting an amount of the secondary magnetic field comprises generating a third magnetic field for reducing a strength of the secondary magnetic field in a direction toward the receive antenna.

18. A wireless power receiver, comprising:
a receive antenna configured to generate charging current in response to a primary magnetic field, wherein a secondary magnetic field is generated by an eddy current in the wireless power receiver; and
a field adjustment element located between the receive antenna and a metal structure of the wireless power receiver, the field adjustment element configured to adjust an amount of the secondary magnetic field, wherein the field adjustment element is chosen from the group consisting of a field blocking element configured to reduce a strength of the secondary magnetic field in a direction toward the receive antenna, a field blocking element configured to reduce a strength of the primary magnetic field in a direction toward the metal structure of the wireless power receiver such that the secondary magnetic field is substantially reduced, and a field altering element configured to generate a third magnetic field, the third magnetic field configured to reduce a strength of the secondary magnetic field in a direction toward the receive antenna.

19. The wireless power receiver of claim 18, wherein the field adjustment element comprises at least one shorted coil configured to reduce a strength of the secondary magnetic field in a direction toward the receive antenna.

20. The wireless power receiver of claim 18, wherein the field adjustment element comprises at least one ferrite element configured to reduce a strength of the secondary magnetic field in a direction toward the receive antenna.

21. The wireless power receiver of claim 18, wherein the field adjustment element comprises at least one of a coil and a ferrite element configured to reduce a strength of the primary magnetic field in a direction toward the metal structure of the wireless power receiver.

22. The wireless power receiver of claim 18, wherein the field adjustment element comprises at least one inverted coil having a first coil portion and a second coil portion, the first coil portion being inverted with respect to the second coil portion, the at least one inverted coil configured to generate a third magnetic field configured to reduce a strength of the secondary magnetic field in a direction toward the receive antenna.

23. The wireless power receiver of claim 18, wherein the field adjustment element comprises:
at least one first coil wound in a first direction and located outside a periphery of the receive antenna; and
at least one second coil wound in a second direction and located inside a periphery of the receive antenna, the first coil and the second coil configured to generate a third magnetic field configured to reduce a strength of the secondary magnetic field in a direction toward the receive antenna.

24. A device for wireless power transfer, comprising:
means for generating a charging current in response to a primary magnetic field; and
means for limiting an amount of a secondary magnetic field that reaches the means for generating the charging current.

25. The device of claim 24, wherein the secondary magnetic field is generated by an eddy current in the device and the means for limiting an amount of the secondary magnetic field comprises means for reducing a strength of the secondary magnetic field in a direction toward the means for generating the charging current.

26. The device of claim 24, wherein the means for limiting an amount of the secondary magnetic field comprises means for reducing a strength of the primary magnetic field in a direction toward a metal structure of the device such that the secondary magnetic field is substantially prevented from forming.

27. The device of claim 26, wherein the means for reducing a strength of the primary magnetic field in a direction toward the metal structure of the device reduces an amount of an eddy current forming in a periphery of the metal structure of the device.

28. The device of claim 24, wherein the means for limiting an amount of the secondary magnetic field comprises means for generating a third magnetic field for reducing a strength of the secondary magnetic field in a direction toward the means for generating the charging current.
